(19) United States
(12) Patent Application Publication
(10) Pub. No.: US 2019/0108284 A1
(43) Pub. Date: Apr. 11, 2019

(54) INFORMATION COLLECTION SYSTEM, INFORMATION COLLECTION METHOD, AND STORAGE MEDIUM

(71) Applicant: FUJITSU LIMITED, Kawasaki-shi (JP)

(72) Inventor: Kazuhito MATSUDA, Kawasaki (JP)

(73) Assignee: FUJITSU LIMITED, Kawasaki-shi (JP)

(21) Appl. No.: 16/150,788

(22) Filed: Oct. 3, 2018

(30) Foreign Application Priority Data
Oct. 10, 2017 (JP) 2017-197006

(51) Int. Cl. G06F 17/30

(52) U.S. Cl. CPC G06F 17/30867; G06F 17/30997; G06F 17/30631; G06F 17/30616

(57) ABSTRACT

An information collection system includes a center server that collects meta information including a key and a value; and an edge server that transmits the meta information to the center server, wherein the edge server is configured to: select the key for managing an appearance frequency of the value, based on characteristics of the meta information, update an appearance frequency of the value corresponding to the selected key, and generating a template of a combination of a target value whose the updated appearance frequency is greater than a threshold frequency and a target key corresponding to the target value.

### CROSS-REFERENCE TO RELATED APPLICATION

This application is based upon and claims the benefit of priority of the prior Japanese Patent Application No. 2017-197006, filed on Oct. 10, 2017, the entire contents of which are incorporated herein by reference.

### FIELD

The embodiment discussed herein is related to an information collection system, an information collection method, and a storage medium.

### BACKGROUND

A technique of reducing the amount of communication of a network for acquiring meta information is known (refer to, for example, Japanese Laid-open Patent Publication No. 2012-033083). Cloud computing and edge computing which is a derivative thereof are known as a computer usage form (refer to, for example, Japanese National Publication of Patent Application No. 2015-505404).

The edge computing means a usage form in which another server (hereinafter, referred to as an edge server) closer to an end user is installed in addition to a server (hereinafter, referred to as a center server) corresponding to a cloud. The edge server may distribute load of the cloud. The edge server may suppress delay caused by communication by performing processing of demanding high-speed response instead of the cloud (refer to, for example, Japanese Laid-open Patent Publication No. 2017-126238).

However, the edge server described above receives data (for example, sensing data, and the like) generated and transmitted by a device of the end user. The device of the end user is not limited to a personal computer (PC), a smart phone, or the like, and recently, many devices such as an environmental sensor, a beacon terminal, an automobile, and a household appliance are targeted. The edge server receives data transmitted from such a device, but even if the received data is transmitted to the center server as it is, all the received data is not used, and thus, there is a concern that the transmission cost is wasted.

For example, the edge server may manage the detailed information, position, and the like of the received data, and may transmit meta information representing an attribute of the data such as a name and a type of the data to the center server. Thereby, the center server may provide a data search service using the meta information. However, there is a concern that, if performance of a communication line between the edge server and the center server is low (for example, a narrow bandwidth), the edge server may not transmit the meta information normally. In view of this, it is desirable to be able to adaptively reduce a traffic between the edge server and the center server.

### SUMMARY

According to an aspect of the embodiments, an information collection system includes a center server that collects meta information including a key and a value; and an edge server that transmits the meta information to the center server, wherein the edge server is configured to: select the key for managing an appearance frequency of the value, based on characteristics of the meta information, update an appearance frequency of the value corresponding to the selected key, and generating a template of a combination of a target value whose the updated appearance frequency is greater than a threshold frequency and a target key corresponding to the target value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an information collection system;

FIG. 2 is an example of a hardware configuration of an edge server;

FIG. 3 is an example of a block diagram of the edge server and a center server;

FIG. 4A is an example of data;

FIG. 4B is an example of key arrangement pair;

FIG. 5A is an example of a key LFU arrangement;

FIG. 5B is an example of a templatization target candidate list;

FIG. 5C is an example of an LFU arrangement maintenance target list;

FIG. 5D is an example of a template list;

FIGS. 6A, 6B, 6C, and 6D are examples of processing sequence diagrams of the information collection system;

FIG. 7 is a flowchart illustrating an example of meta information retainment processing;

FIG. 8 is a flowchart illustrating an example of first update processing;

FIG. 9 is a flowchart illustrating an example of second update processing;

FIG. 10 is a flowchart illustrating an example of meta information conversion processing;

FIG. 11 is a flowchart illustrating an example of meta information collection processing;

FIG. 12 is a diagram illustrating conversion of meta information and decoding of registration information;

FIG. 13A is a flowchart illustrating an example of first determination processing;

FIG. 13B is a flowchart illustrating an example of second determination processing;

FIG. 14 is a diagram illustrating the numbers of elements of the key arrangement pair;

FIG. 15 is a flowchart illustrating an example of template generation processing;

FIG. 16 is a flowchart illustrating an example of template response processing; and

FIG. 17 is a diagram illustrating generation of a template list.

### DESCRIPTION OF EMBODIMENTS

Hereinafter, forms for performing the present disclosure will be described with reference to the drawings.

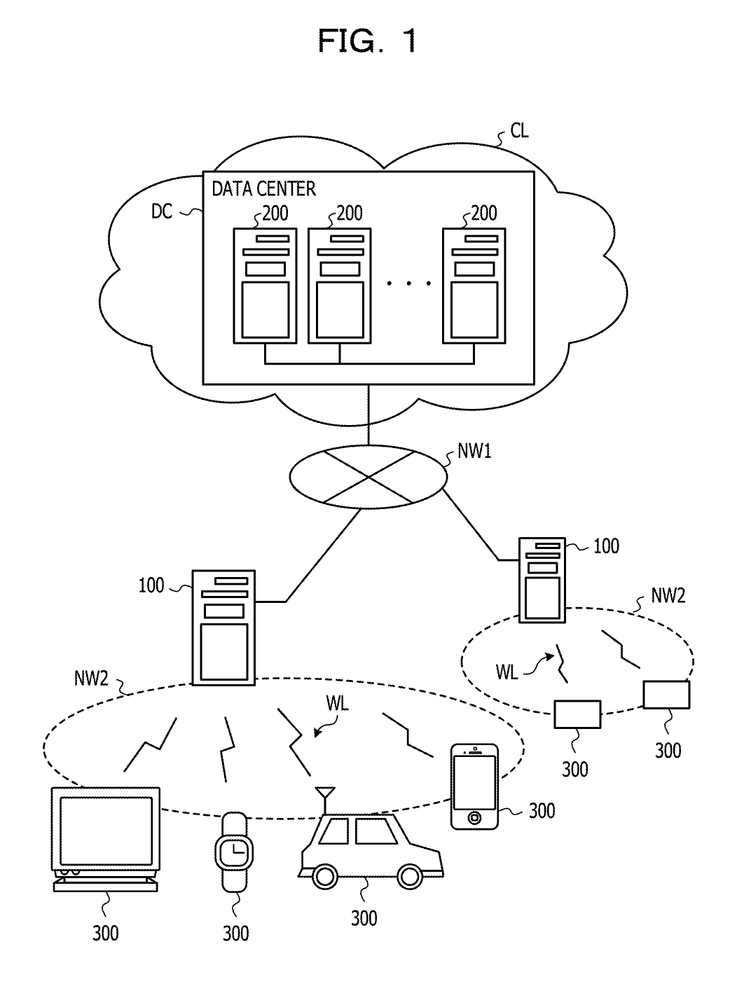

FIG. 1 is a diagram illustrating an example of an information collection system S. The information collection system S includes an edge server 100 and a center server 200. The edge server 100 and the center server 200 are connected to each other by a communication network NW1. The communication network NW1 is, for example, the Internet.

The edge server 100 may receive data transmitted from various devices (for example, an Internet of things (IoT) device) 300 used by an end user via a communication network NW2 that provides a wireless communication WL. The device 300 includes, for example, a moving object such as an automobile, a household appliance such as a smart television, a wearable terminal such as a smart watch, a smart terminal such as a smartphone or a tablet terminal, an environmental sensor such as an illuminance sensor or a temperature sensor, and the like. The communication network NW2 is, for example, a wide area wireless communication network such as a Long Term Evolution (LTE) network. The communication network NW2 is not limited to the wide area wireless communication network. The communication network NW2 may be, for example, a short-distance wireless communication network such as the Wi-Fi® or the Bluetooth®, or a wired communication network of narrowband communication.

As illustrated in FIG. 1, the edge server 100 is disposed at a position closer to an end user side than the center server 200. For example, the edge server 100 is disposed between the center server 200 and the device 300. The edge server 100 is, for example, an IoT gateway apparatus, a portable base station, or a node device such as an access point. The edge server 100 receives data transmitted from the device 300 by using the wireless communication WL. If the data is received, the edge server 100 stores meta information included in the received data. The edge server 100 may store the detailed information and position of the received data. The edge server 100 converts a template into registration information by applying to the meta information included in the received data, and transmits the registration information to the center server 200. For example, if the template is applied to the meta information, the meta information is converted into the registration information. As will be described in detail below, the template is information representing a model for suppressing transmission of duplicate content.

The center server 200 is a node device included in the data center DC or the like on the cloud CL. The center server 200 receives the registration information transmitted from the edge server 100 and decodes the received registration information by applying the above-described template. The center server 200 stores the meta information that appears by decoding the registration information. As such, the center server 200 collects or aggregates (hereinafter, simply referred to as collect) the meta information.

Hereinafter, the edge server 100 and the center server 200 which are described above will be described in detail.

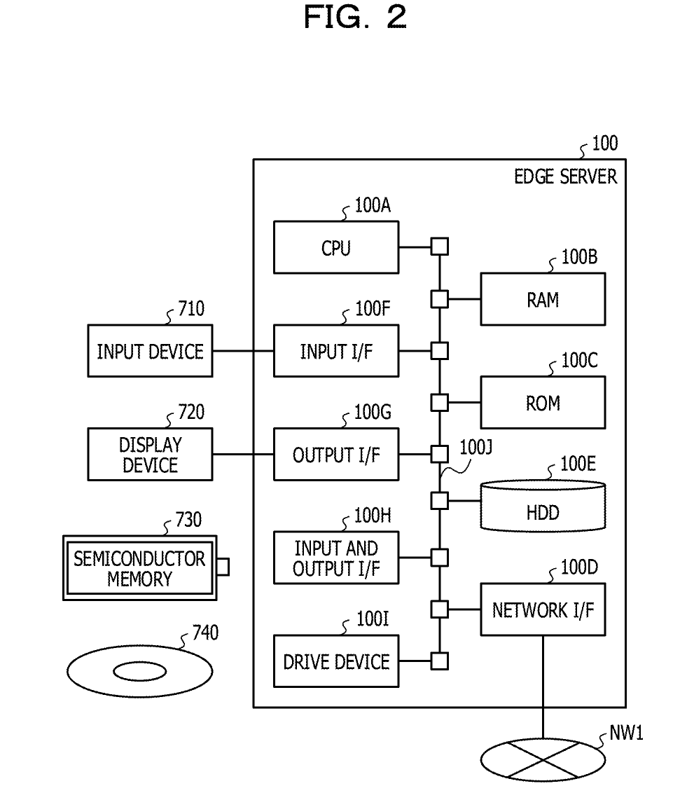

FIG. 2 is an example of a hardware configuration of the edge server 100. Basically, the above-described center server 200 has the same hardware configuration as the edge server 100, and thus, description thereof will be omitted. As illustrated in FIG. 2, the edge server 100 includes at least a central processing unit (CPU) 100A as at least a hardware processor, a random access memory (RAM) 100B, a read only memory (ROM) 100C, and a network interface (I/F) 100D. The edge server 100 may include at least one of a hard disk drive (HDD) 100E, an input I/F 100F, an output I/F 100G, an input and output I/F 100H, and a drive device 100I as demanded. The CPU 100A to the drive device 100I are connected to each other by an internal bus 100J. At least the CPU 100A and the RAM 100B cooperate to realize a computer. Instead of the CPU 100A, a micro processing unit (MPU) may be used as a hardware processor.

An input device 710 is connected to the input I/F 100F. The input device 710 is, for example, a keyboard, a mouse, or the like. A display device 720 is connected to the output I/F 100G. The display device 720 is, for example, a liquid crystal display. The input and output I/F 100H is connected to a semiconductor memory 730. The semiconductor memory 730 is, for example, a Universal Serial Bus (USB) memory, a flash memory, or the like. The input and output I/F 100H reads a program or data stored in the semiconductor memory 730. The input I/F 100F and the input and output I/F 100H have, for example, USB ports. The output I/F 100G includes, for example, a display port.

A portable recording medium 740 is inserted into the drive device 100I. The portable recording medium 740 includes, for example, a removable disk such as a compact disc (CD)-ROM, a digital versatile disc (DVD). The drive device 100I reads a program or data recorded in the portable recording medium 740. The network I/F 100D includes, for example, a LAN port. The network I/F 100D is connected to the communication network NW1 described above.

The program stored in the ROM 100C or the HDD 100E is stored in the RAM 100B described above by the CPU 100A. The program recorded in the portable recording medium 740 is stored in the RAM 100B by the CPU 100A. As the stored program is executed by the CPU 100A, the CPU 100A realizes various functions which will be described below and performs various types of processing which will be described below. The program may correspond to a processing sequence diagram or a flowchart which will be described below.

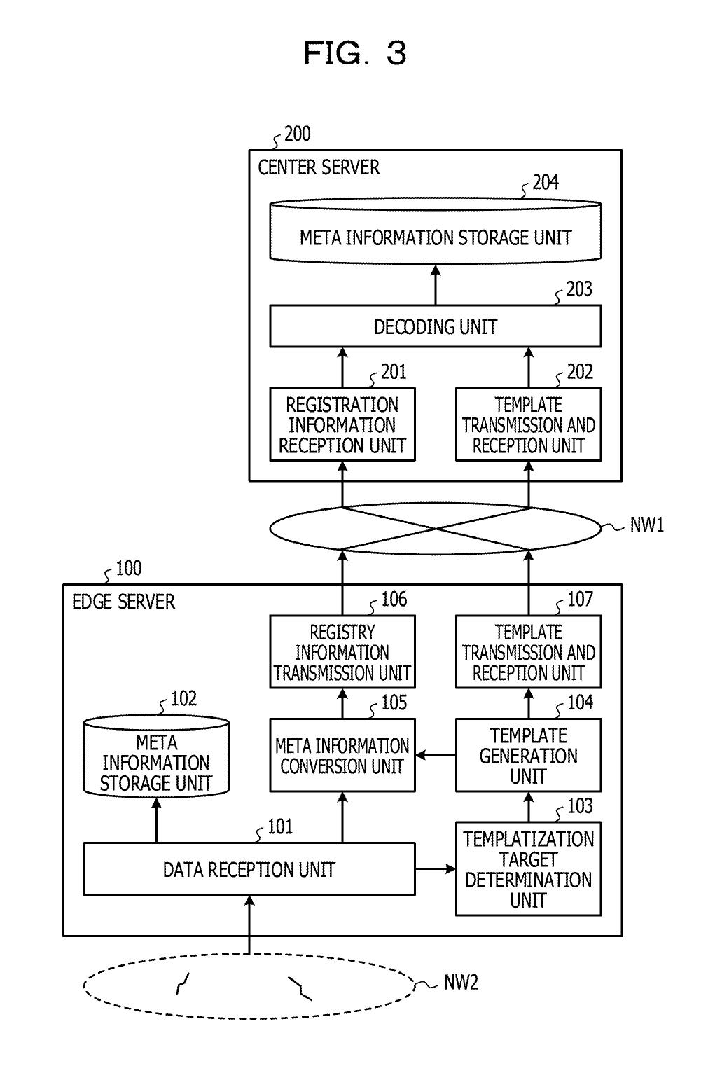

Next, functions of the edge server 100 and the center server 200 will be described with reference to FIGS. 3 to 5D.

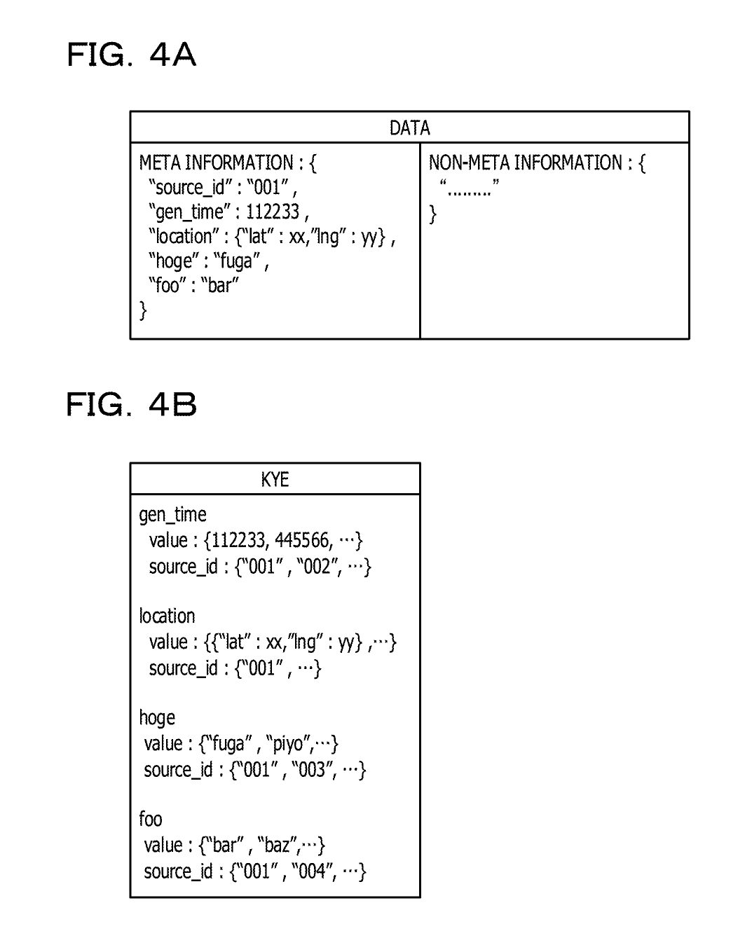

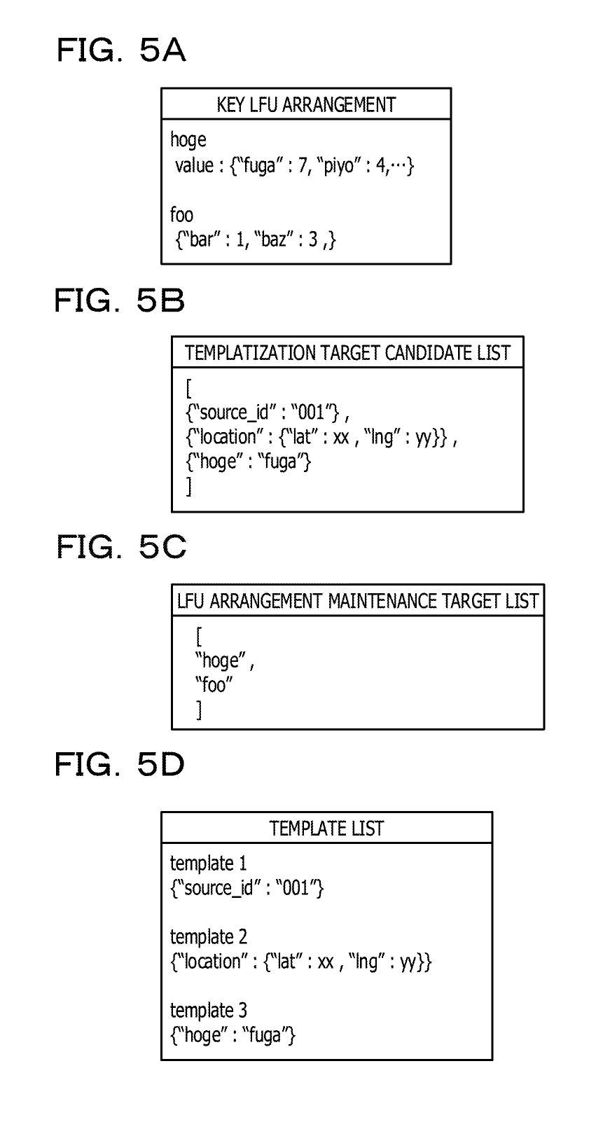

FIG. 3 is an example of a block diagram of the edge server 100 and the center server 200. FIG. 4A is an example of data. FIG. 4B is an example of key arrangement pair. FIG. 5A is an example of a key LFU arrangement. FIG. 5B is an example of a templatization target candidate list. FIG. 5C is an example of an LFU arrangement maintenance target list. FIG. 5D is an example of a template list.

First, the edge server 100 will be described. As illustrated in FIG. 3, the edge server 100 includes a data reception unit 101 and a meta information storage unit 102. The edge server 100 includes a templatization target determination unit 103, a template generation unit 104, and a meta information conversion unit 105. The edge server 100 includes a registration information transmission unit 106 and a template transmission and reception unit 107. The meta information storage unit 102 may be realized by, for example, the HDD 100E described above. The templatization target determination unit 103, the template generation unit 104, and the meta information conversion unit 105 may be realized by, for example, the CPU 100A and the RAM 100B which are described above. The data reception unit 101, the registration information transmission unit 106, and the template transmission and reception unit 107 may be realized by, for example, the network I/F 100D described above.

The data reception unit 101 receives data transmitted from the device 300 via the communication network NW2 that provides the wireless communication WL. As illustrated in FIG. 4A, the data received by the data reception unit 101 includes key-value type meta information and non-meta information other than meta information. The key may be referred to as an item name, and the value may be referred to as an item value. For example, the meta information includes source_id representing an identifier of the device 300, gen_time representing a data generation time, location representing a position where the device 300 is installed, and the like, as a key. For example, the meta information may include content_type representing the type of data, detected_object representing a detection target, and the like, as a key. A specific value and the like are associated with each of the keys. If data is received, the data reception unit 101 retains the meta information of the received data in the meta information storage unit 102. Then, the data reception unit 101 outputs the meta information to the templatization target determination unit 103 and the meta information conversion unit 105. The data reception unit 101 may retain the detailed information and position of the received data in the meta information storage unit 102.

If the meta information output from the data reception unit 101 is received, the templatization target determination unit 103 generates a key arrangement pair by using the received meta information and holds the key arrangement pair. The key arrangement pair is information which is used when determining whether or not a combination of a key and a value is a templatization target. As illustrated in FIG. 4B, for each key of the meta information except for source_id, the key arrangement pair includes a first arrangement for inserting the value of the key and a second arrangement for inserting the value of source_id. If the meta information is received, the templatization target determination unit 103 compares the received meta information with the key arrangement pair and determines whether or not the value is duplicated for each key. If it is determined that the value is not duplicated, the templatization target determination unit 103 inserts the value of the key except for source_id into the first arrangement and inserts the value of source_id into the second arrangement.

If the meta information output from the data reception unit 101 is received, the templatization target determination unit 103 generates a key LFU arrangement using the received meta information and holds the key LFU arrangement. The key LFU arrangement is information that determines an appearance frequency of the value included in the meta information, based on a least frequently used (LFU) algorithm. As illustrated in FIG. 5A, the key LFU arrangement includes a value corresponding to the key and an LFU arrangement for managing the appearance frequency of the value for each value, for each key. If the meta information is received, the templatization target determination unit 103 compares the received meta information with the key LFU arrangement and determines whether or not the value is duplicated for each key. If it is determined that the value is duplicated, the templatization target determination unit 103 increments the appearance frequency of the value. For example, if the templatization target determination unit 103 receives the meta information illustrated in FIG. 4A, the appearance frequency is increased by one for each of a value fuga of the key hoge and a value bar of the key foo. Thereby, as illustrated in FIG. 5A, the appearance frequency of the value fuga becomes 7, and the appearance frequency of the value bar becomes 1.

The template generation unit 104 generates a template list. For example, first, the template generation unit 104 determines whether or not a combination of the key and the value is included in the templatization target candidate list, and whether or not the key is included in the LFU arrangement maintenance target list, by using the number of elements of the first arrangement and the second arrangement, with reference to the key arrangement pair held in the templatization target determination unit 103. As illustrated in FIG. 5B, the templatization target candidate list is information in which combinations of keys and values a templatization target are listed. Meanwhile, as illustrated in FIG. 5C, the LFU arrangement maintenance target list is information in which keys managed in the key LFU arrangement are listed. If it is determined that the appearance frequency of the values of the keys managed in the LFU arrangement maintenance target list is higher than or equal to a threshold frequency, the template generation unit 104 adds a combination of the value and the key corresponding to the value to the templatization target candidate list and holds the combination. In the present embodiment, since a numerical value “5” is used as the threshold frequency, a combination of the value fuga and the key hoge in which the appearance frequency is 7 is added (see FIG. 5B), and the numerical value of the threshold frequency is not limited in particular.

Although details will be described below, the template generation unit 104 periodically transmits the templatization target candidate list to the center server 200 through the template transmission and reception unit 107. If the template ID transmitted from the center server 200 is received through the template transmission and reception unit 107, the template generation unit 104 generates a template list in which the templatization target candidate list and the template ID are associated with each other and holds the template list, as illustrated in FIG. 5D. The template ID is information for identifying a template. For example, if a combination of a key and a value included in the template list is included in the meta information, the combination of the key and the value is replaced with the template “1”, “2”, or the like.

The meta information conversion unit 105 converts the meta information into registration information. For example, if the meta information output from the data reception unit 101 is received, the meta information conversion unit applies the template list to the received meta information with reference to the template list held by the template generation unit 104, and converts the meta information into the registration information. If the meta information is converted into the registration information, the meta information conversion unit 105 outputs the registration information to the registration information transmission unit 106.

The registration information transmission unit 106 transmits the registration information output from the meta information conversion unit 105 to the center server 200. The template transmission and reception unit 107 transmits the templatization target candidate list (see FIG. 5B) output from the template generation unit 104 to the center server 200. The template transmission and reception unit 107 outputs the template ID transmitted from the center server 200 to the template generation unit 104.

Next, the center server 200 will be described. As illustrated in FIG. 3, the center server 200 includes a registration information reception unit 201 and a template transmission and reception unit 202. The center server 200 includes a decoding unit 203 and a meta information storage unit 204. The registration information reception unit 201 and the template transmission and reception unit 202 may be realized by, for example, the network I/F 100D described above. The decoding unit 203 may be realized by, for example, the CPU 100A and the RAM 100B described above. The meta information storage unit 204 may be realized by, for example, the HDD 100E described above.

The registration information reception unit 201 receives the registration information transmitted from the edge server 100, and outputs the registration information to the decoding unit 203. The template transmission and reception unit 202 receives the templatization target candidate list (see FIG. 5B) transmitted from the edge server 100, and outputs the templatization target candidate list to the decoding unit 203. The template transmission and reception unit 202 receives the template ID output from the decoding unit 203 and transmits the received template ID to the edge server 100.

If the templatization target candidate list (see FIG. 5B) output from the template transmission and reception unit 202 is received, the decoding unit 203 generates template IDs for each combination of the keys and the values and outputs the template ID to the template transmission and reception unit 202. The decoding unit 203 generates and holds a template list in which the generated template ID and the templatization target candidate list are associated with each other. The decoding unit 203 decodes the registration information output from the registration information reception unit 201 into the template list held by itself, and retains the meta information appearing by decoding the registration information in the meta information storage unit 204.

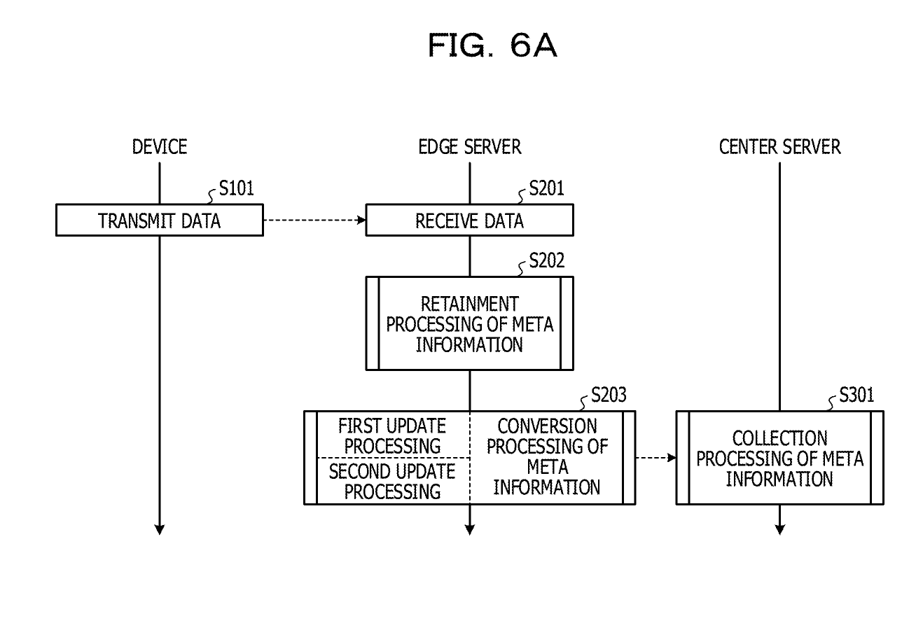

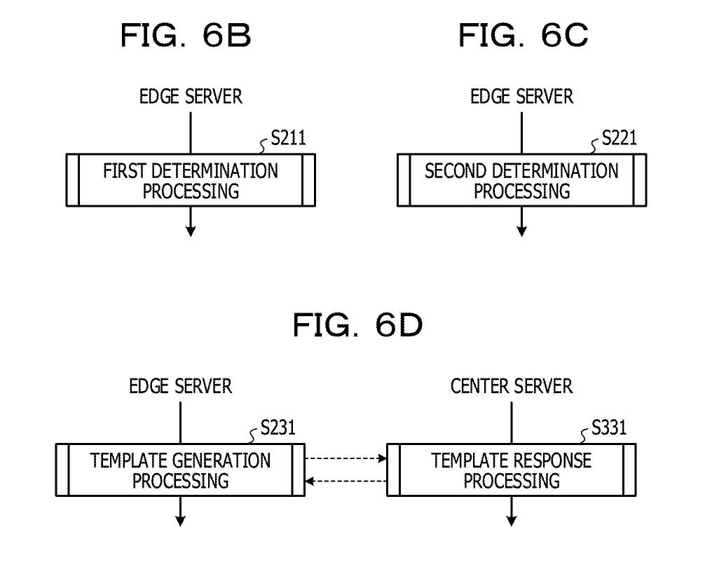

Subsequently, an operation of the information collection system S will be described with reference to FIGS. 6A, 6B, 6C, and 6D.

FIGS. 6A, 6B, 6C, and 6D are examples of processing sequence diagrams of the information collection system S. First, as illustrated in FIG. 6A, if the device 300 transmits data (S101), the data reception unit 101 of the edge server 100 receives the data (S201). If the data reception unit 101 receives the data, the data reception unit 101 performs meta information retainment processing (S202). Details of the meta information retainment processing will be described below.

If the processing of S202 is completed, the templatization target determination unit 103 performs first update processing and second update processing, and the meta information conversion unit 105 and the registration information transmission unit 106 perform meta information conversion processing (S203). Although details thereof will be described below, the first update processing is processing of inserting a value into the first arrangement and the second arrangement of the key arrangement pair (see FIG. 4B). The second update processing is processing of updating an appearance frequency of the value included in the key LFU arrangement. The meta information conversion processing is processing of converting meta information into registration information and transmitting the converted registration information. The first update processing, the second update processing, and the meta information conversion processing are performed in parallel. The templatization target determination unit 103 may perform the second update processing after the first update processing is performed, or may perform the first update processing and the second update processing in parallel.

If the registration information is transmitted during the meta information conversion processing of S203, the registration information reception unit 201 and the decoding unit 203 of the center server 200 perform meta information collection processing (S301). Although details will be described below, the meta information collection processing is processing of decoding registration information and retaining the meta information. The edge server 100 and the center server 200 repeat the above-described processing each time data is transmitted from the device 300.

Next, as illustrated in FIG. 6B, the template generation unit 104 of the edge server 100 performs first determination processing (S211). For example, the template generation unit 104 performs the first determination processing periodically and independently without being synchronized with the various types of processing described with reference to FIG. 6A. The first determination processing is processing of determining whether or not to include a combination of a key and a value in the templatization target candidate list and whether or not to include the key in the LFU arrangement maintenance target list, by using the number of the respective elements of the first arrangement and the second arrangement included in the key arrangement pair. Details of the first determination processing will be described below.

Next, as illustrated in FIG. 6C, the template generation unit 104 of the edge server 100 performs second determination processing (S221). For example, the template generation unit 104 performs the second determination processing periodically and independently without being synchronized with the various types of processing described with reference to FIG. 6A. The second determination processing is processing of determining whether or not to include a combination of a value included in the key LFU arrangement (see FIG. 5A) and a key corresponding to the value in the templatization target candidate list (see FIG. 5B). Details of the second determination processing will be described below.

Next, as illustrated in FIG. 6D, the template generation unit 104 and the template transmission and reception unit 107 of the edge server 100 perform template generation processing (S231), and the template transmission and reception unit 202 and the decoding unit 203 of the center server 200 perform template response processing (S311). For example, the template generation unit 104 and the template transmission and reception unit 107 perform the template generation processing periodically and independently without being synchronized with the various types of processing described with reference to FIG. 6A. Meanwhile, the template transmission and reception unit 202 and the decoding unit 203 perform the template response processing as the template generation unit 104 and the template transmission and reception unit 107 perform the template generation processing. The template generation processing is processing of transmitting the templatization target candidate list (see FIG. 5B) to the center server 200 and generating the template list (see FIG. 5D) by using the template ID received from the center server 200. Meanwhile, the template response processing is processing of generating a template ID and transmitting the template ID to the edge server 100. Details of the template generation processing and the template response processing will be described below.

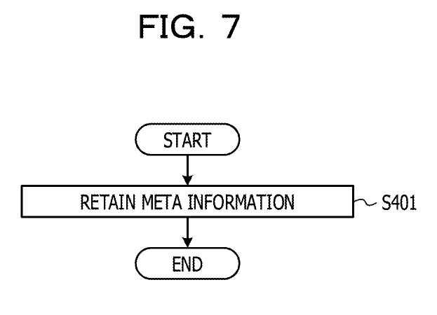

Next, the above-described meta information retainment processing will be described with reference to FIG. 7.

FIG. 7 is a flowchart illustrating an example of meta information retainment processing. If the data reception unit 101 performs the processing of S201 as described with reference to FIG. 6A, the data reception unit 101 retains the meta information in the meta information storage unit 102 as illustrated in FIG. 7 (S401). For example, the data reception unit 101 extracts the meta information from the received data and retains the extracted meta information. Thereby, the meta information storage unit 102 stores the meta information. The data reception unit 101 may retain the detailed information (for example, non-meta information, and the like) and position of the received data in the meta information storage unit 102.

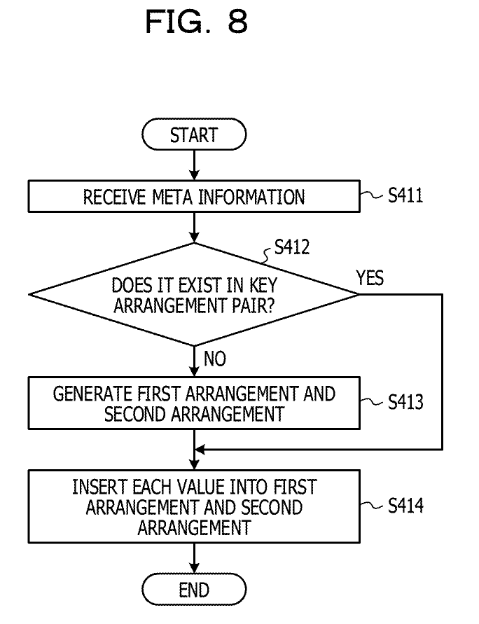

Next, the first update processing described above will be described with reference to FIG. 8.

FIG. 8 is a flowchart illustrating an example of the first update processing. If the data reception unit 101 ends performing the processing of S202 as described with reference to FIG. 6A, the templatization target determination unit 103 receives the meta information output from the data reception unit 101 as illustrated in FIG. 8 (S411). If the meta information is received, the templatization target determination unit 103 determines whether or not each key included in the received meta information exists in the key arrangement pair (see FIG. 4B) (S412).

In a case where it is determined that there is no key in the key arrangement pair (S412: NO), the templatization target determination unit 103 generates the first arrangement and the second arrangement of the nonexistent keys in the key arrangement pair (S413). Meanwhile, in a case where it is determined that each key included in the received meta information exists in the key arrangement pair (S412: YES), the templatization target determination unit 103 skips the processing of S413.

In a case where the processing of S413 is completed or in a case where the processing of S413 is skipped, the templatization target determination unit 103 inserts each value into the first arrangement and the second arrangement (S414). In more detail, the templatization target determination unit 103 inserts a value of the key except for source_id into the first arrangement and inserts a value of source_id into the second arrangement. As such, the templatization target determination unit 103 updates the key arrangement pair (see FIG. 4B).

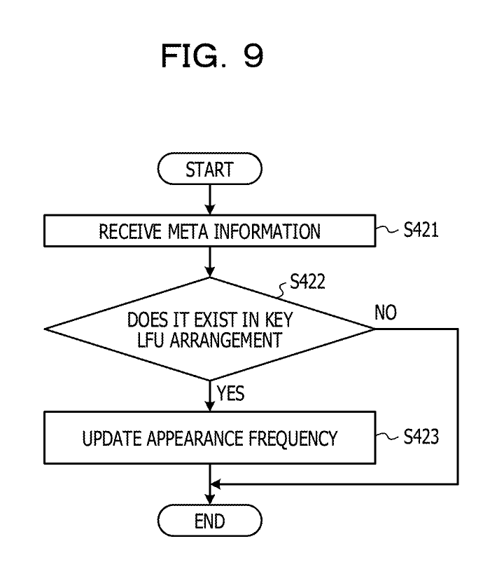

Next, the second update processing described above will be described with reference to FIG. 9.

FIG. 9 is a flowchart illustrating an example of the second update processing. If the data reception unit 101 ends performing the processing of S202 as described with reference to FIG. 6A, the templatization target determination unit 103 receives the meta information output from the data reception unit 101 as illustrated in FIG. 9 (S421). If the meta information is received, the templatization target determination unit 103 determines whether or not a key included in the received meta information exists in the key LFU arrangement (see FIG. 5A) (S422).

In a case where it is determined that there is any key in the key LFU arrangement (S422: YES), the templatization target determination unit 103 updates the appearance frequency of the values associated with the existing key (S423). In more detail, the templatization target determination unit 103 increments the appearance frequency of the value. Meanwhile, in a case where it is determined that the key included in the received meta information does not exist in the key LFU arrangement (S422: NO), the templatization target determination unit 103 skips the processing of S423. As such, the templatization target determination unit 103 updates the key LFU arrangement (see FIG. 5A).

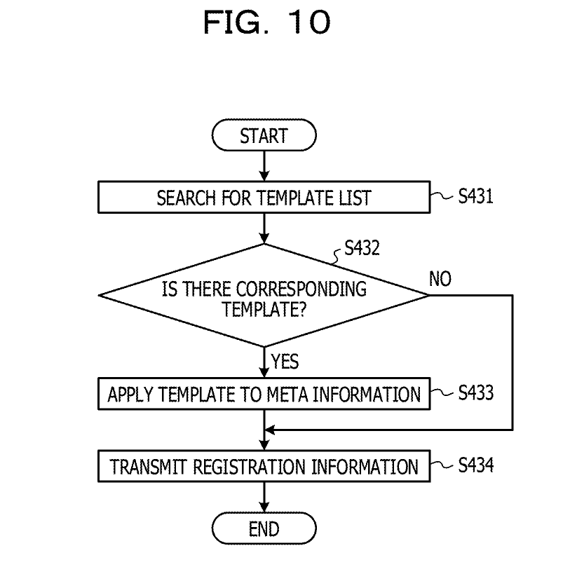

Next, the meta information conversion processing and meta information collection processing described above will be described with reference to FIGS. 10 to 12.

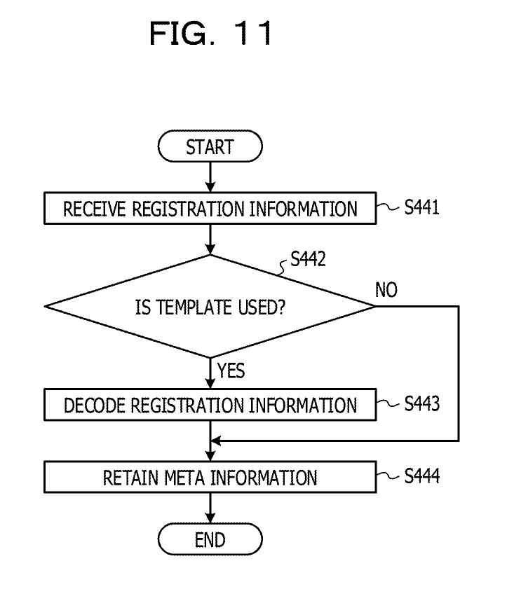

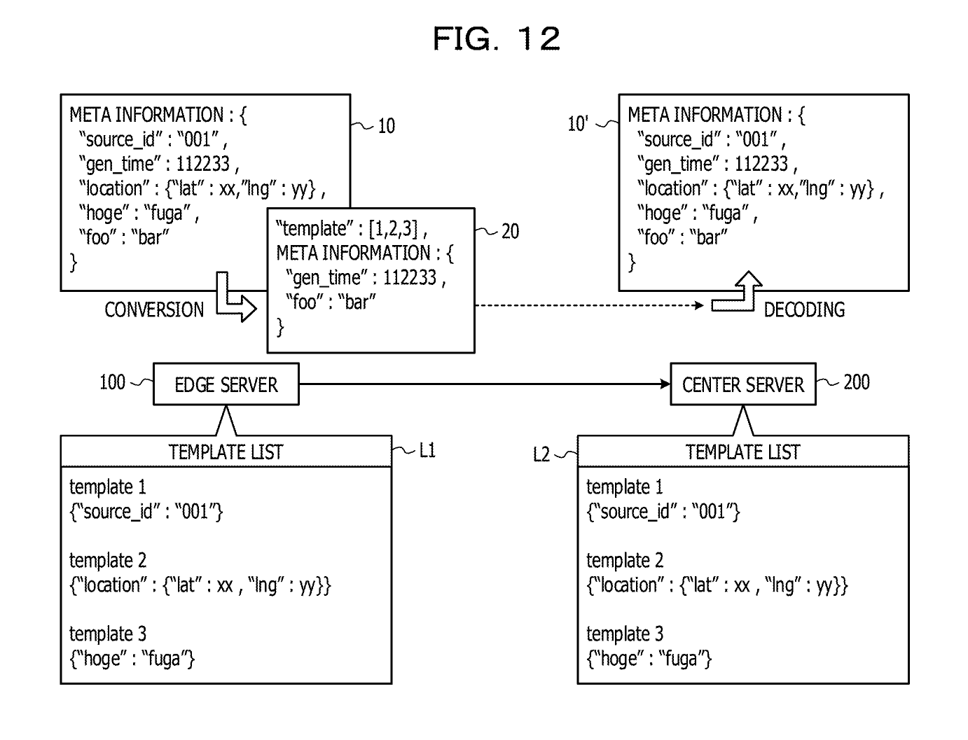

FIG. 10 is a flowchart illustrating an example of meta information conversion processing. FIG. 11 is a flowchart illustrating an example of the meta information collection processing. FIG. 12 is a diagram illustrating conversion of the meta information and decoding of the registration information. If the data reception unit 101 ends performing the processing of S202 as described with reference to FIG. 6A, the meta information conversion unit 105 searches for the template list held in the template generation unit 104 (S431) and determines whether or not there is a corresponding template (S432) as illustrated in FIG. 10. For example, as illustrated in FIG. 12, in a case where the edge server 100 (for example, the template generation unit 104) holds a template list L1, the meta information conversion unit 105 searches for the template list L1 and determines whether or not there is a template corresponding to a combination of the key and the value of the meta information 10 in the template list L1.

In a case where it is determined that there is the corresponding template (S432: YES), the meta information conversion unit 105 applies a template to the meta information (S433), and the registration information transmission unit 106 transmits the registration information (S434). For example, as illustrated in FIG. 12, regarding a combination of source_id and 001 of the meta information 10, a template “1” exists in the template list L1. In the same manner, regarding a combination of location and {“lat”: xx, “lng”: yy} of the meta information 10, a template “2” exists in the template list L1. Regarding a combination of hoge and fuga of the meta information 10, a template “3” exists in the template list L1. Accordingly, the meta information conversion unit 105 converts meta information 10 into registration information 20 by applying the templates “1”, “2”, and “3” to the meta information 10. If the meta information conversion unit 105 converts the meta information 10 into the registration information 20, the registration information transmission unit 106 transmits the registration information 20 to the center server 200 (for example, the registration information reception unit 201).

During the processing of S434, if the registration information transmission unit 106 transmits the registration information, the registration information reception unit 201 receives the registration information (S441), and the decoding unit 203 determines whether or not the registration information uses the template as illustrated in FIG. 11 (S442). For example, as illustrated in FIG. 12, if the center server 200 (for example, the registration information reception unit 201) receives the registration information 20, the decoding unit 203 determines whether or not the registration information 20 includes the template.

In a case where it is determined that the registration information uses the template (S442: YES), the decoding unit 203 decodes the registration information (S443) and retains the meta information (S444). For example, as illustrated in FIG. 12, since the registration information 20 includes the templates “1”, “2”, and “3”, the decoding unit 203 determines that the registration information 20 uses the template, and decodes the registration information 20 by using the template list L2 held in the decoding unit 203. If the registration information 20 is decoded, the decoding unit 203 retains meta information 10′ decoded by the registration information 20 in the meta information storage unit 204.

In a case where the decoding unit 203 determines that the registration information does not use the template (S442: NO), the template is not applied to the registration information, and thus, the contents of the registration information 20 and the meta information 10 are common. Accordingly, the decoding unit 203 skips the processing of S443 and performs the processing of S444.

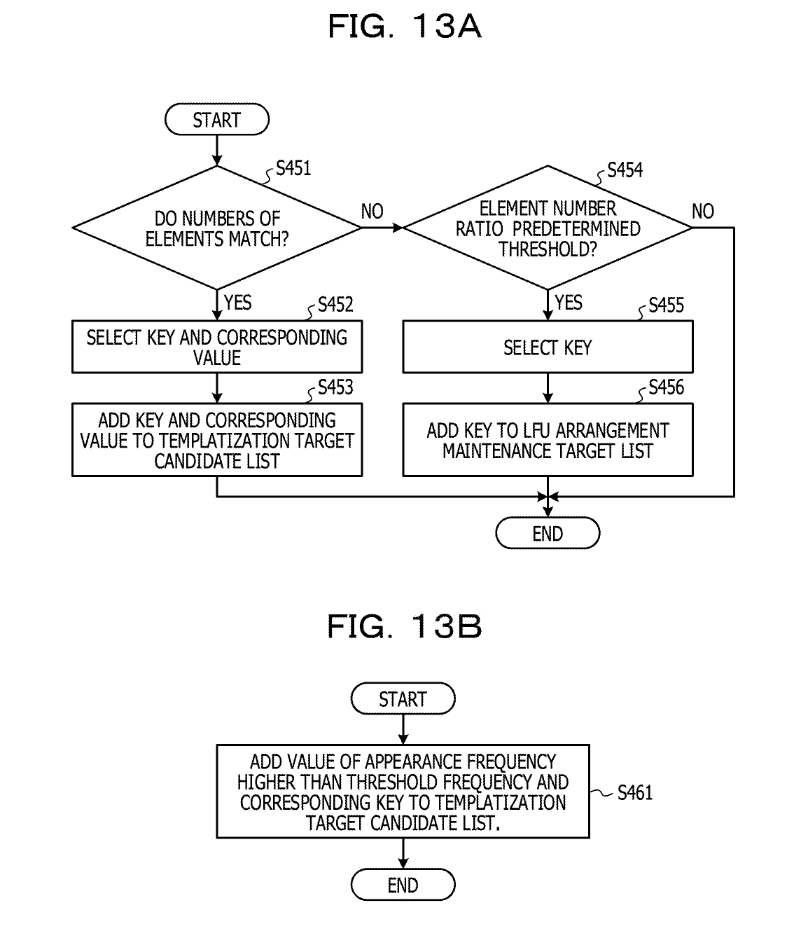

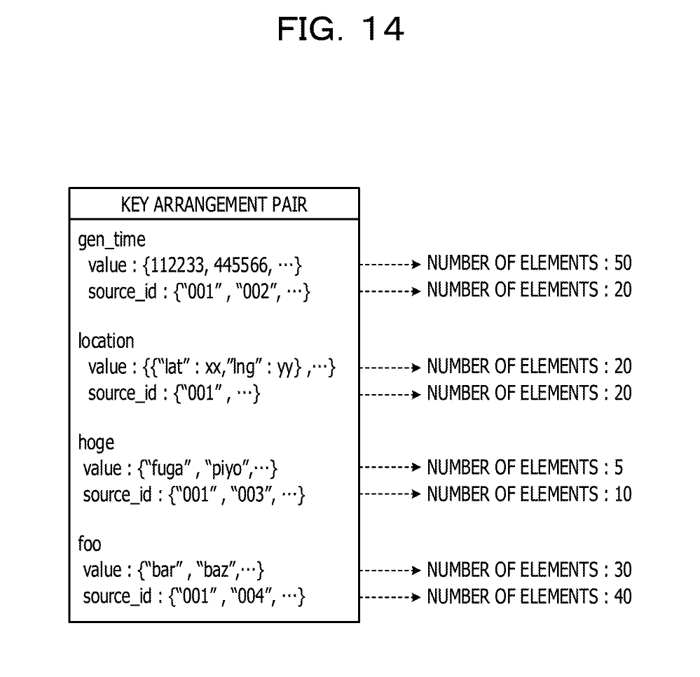

Next, the first determination processing and the second determination processing described above will be described with reference to FIG. 13 and FIG. 14.

FIG. 13A is a flowchart illustrating an example of the first determination processing. FIG. 13B is a flowchart illustrating an example of the second determination processing. FIG. 14 is a diagram illustrating the numbers of elements of key arrangement pair. As described above, the template generation unit 104 performs the first determination processing independently from the processing described with reference to FIG. 6A. First, as illustrated in FIG. 13A, the template generation unit 104 determines whether or not the number of elements matches (S451). For example, as illustrated in FIG. 14, the template generation unit 104 determines whether or not the number of elements in the first arrangement and the number of elements in the second arrangement match each other for each key, with reference to the key arrangement pair held in the templatization target determination unit 103. The number of the respective elements in the first arrangement and the second arrangement may be referred to as sizes of the first arrangement and the second arrangement.

For example, in location in which the key is 1, the number of elements in the first arrangement is 20 and the number of elements in the second arrangement is 20. In this case, the template generation unit 104 determines that the numbers of elements match each other (S451: YES). If it is determined that the numbers of elements match each other, the template generation unit 104 then selects the key and a value corresponding to the key (S452), and adds the key and the value corresponding to the key to the templatization target candidate list (S453). At that time, the template generation unit 104 adds source_id which is a key corresponding to a combination of the key to be added and the value corresponding to the key, and the value to the templatization target candidate list. Thus, as illustrated in FIG. 14, since the numbers of elements match each other regarding location, the template generation unit 104 selects location and {“lat”: xx, “lng”: yy} corresponding to the location to add to the templatization target candidate list (see FIG. 5B). The template generation unit 104 also adds a combination of source_id and 001 corresponding to a combination of location and {“lat”: xx, “lng”: yy}, to the templatization target candidate list (see FIG. 5B).

Meanwhile, if it is determined that the numbers of elements do not match each other (S451: NO), the template generation unit 104 then determines whether or not an element number ratio is less than or equal to a predetermined threshold (S454). In more detail, as illustrated in FIG. 14, the template generation unit 104 specifies a key in which the number of elements in the first arrangement and the number of elements in the second arrangement do not match each other with reference to the key arrangement pair. Then, the template generation unit 104 calculates the element number ratio representing the number of elements in the first arrangement with respect to the number of elements in the second arrangement of the specified key, and determines whether or not the calculated element number ratio is less than or equal to the predetermined threshold.

For example, in hoge in which a key is 1, the number of elements in the second arrangement is 10, and the number of elements in the first arrangement is 5. In a case where a numerical value “1” is defined as the predetermined threshold, the template generation unit 104 calculates the element number ratio 0.5 (=5/10), and determines that the calculated element number ratio 0.5 is less than or equal to the predetermined threshold “1” (S454: YES). The same is applied to foo in which the key is 1. If it is determined that the element number ratio is less than or equal to the predetermined threshold, the template generation unit 104 then selects the corresponding key (S455) and adds the corresponding key to the LFU arrangement maintenance target list (S456). Thus, as illustrated in FIG. 14, since the element number ratio is less than or equal to the predetermined threshold with respect to hoge and foo, the template generation unit 104 selects hoge and foo and adds hoge and foo to the LFU arrangement maintenance target list (see FIG. 5C). At this time, the template generation unit 104 may add a combination of source_id and the value which is a key corresponding to a combination of the key to be added and a value of the key, to the templatization target candidate list. Thus, the template generation unit 104 may add a combination of source_id and 001 corresponding to a combination of hoge and fuga to the templatization target candidate list. In a case where a combination of source_id and a value of source_id of the same content is included in the templatization target candidate list, the combination may be updated.

In contrast to this, for example, in gen_time in which the key is 1, the number of elements in the second arrangement is 20 and the number of elements in the first arrangement is 50. As described above, in a case where the numerical value “1” is defined as the predetermined threshold, the template generation unit 104 calculates the element number ratio 2.5 (=50/20), and determines that the calculated element number ratio 2.5 is greater than the predetermined threshold “1” (S454: NO). If it is determined that the element number ratio is greater than the predetermined threshold, the template generation unit 104 skips the processing of S455 and S456. Thus, gen_time in which the key is 1 is not included in the LFU arrangement maintenance target list (see FIG. 5C). In a case where a key other than the LFU arrangement maintenance target such as gen_time is included in the LFU arrangement maintenance target list, the template generation unit 104 deletes the key other than the LFU arrangement maintenance target.

In the same manner as the first determination processing, the template generation unit 104 performs the second determination processing independently from the processing described with reference to FIG. 6A. For example, as illustrated in FIG. 13B, the template generation unit 104 adds a value having an appearance frequency higher than a threshold frequency and a corresponding key to the templatization target candidate list (S461). In more detail, the template generation unit 104 determines whether or not the appearance frequency of the value is greater than the threshold frequency for each key with reference to the key LFU arrangement held in the templatization target determination unit 103. In a case where a numerical value “5” is defined as the threshold frequency, the template generation unit 104 specifies fuga and hoge corresponding thereto from the key LFU arrangement (see FIG. 5A), and adds a combination of the specified hoge and fuga to the templatization target candidate list (see FIG. 5B).

As described above, in the present embodiment, all combinations of keys and values are not included in the templatization target candidate, and a part of the combinations of keys and values is selected and included in the templatization target candidate according to characteristics of the meta information. For example, source_id in which the key is 1 is information for identifying the device 300, and the value is not changed basically. Thus, it is desirable to include source_id and a value corresponding thereto in the templatization target candidate. The location in which the key is 1 is information representing a position where the device 300 is installed, basically associates with source_id all the time, thereby, being not changed, unless the position of the device 300 changes (for example, fixed point observation of remote weather, and the like). Thus, the keys and values corresponding thereto may be included in the templatization target candidate. For example, content_type in which the key is 1 is information representing the type of data (for example, image data, voice data, and the like) and is unique in the device 300, and thus, in the same manner, the key and a value corresponding thereto may be included in the templatization target candidate.

Meanwhile, detected_object in which the key is 1 is information representing a detection target (for example, a human, an animal, or the like) and is unique in the device 300, and thus, there is a possibility that the detection target changes. In this case, it is determined whether or not to include in the templatization target candidate by using the number of elements of the value of the key and the number of elements of source_id. For example, temperature, humidity, wind speed, and the like change also in temperature and the like representing a weather condition and the like as the key, and thus, it is determined whether or not to include in the templatization target candidate by using the number of elements of the value and the number of elements of source_id in the same manner. However, gen_time, which is the key, represents data generation time, duplication of values does not occur basically, and thus, gen_time is not included in the templatization target candidate. As such, the templatization target candidate is dynamically determined according to the characteristic of the meta information.

Thereby, although performance of a communication line of the communication network NW1 is low and computer resources (for example, communication capability, processing capability, storage capacity, and the like) of the edge server 100 are in a state of being limited to be less than computer resources of the center server 200, the edge server 100 may adaptively templatize the meta information. The edge server 100 may periodically transmit the templatized meta information.

For example, the edge server 100 specifies a first templatization target depending on whether or not the numbers of elements of the values match each other. In a case where the numbers of elements of the values do not match each other, the edge server 100 limits the key to the number of elements that do not match each other and specifies the templatization target by using the element number ratio between the values corresponding to the limited key. As such, since the templatization target is specified in two stages, a processing load of the edge server 100 is reduced as compared with a case where the appearance frequency of the values corresponding to all the keys is managed.

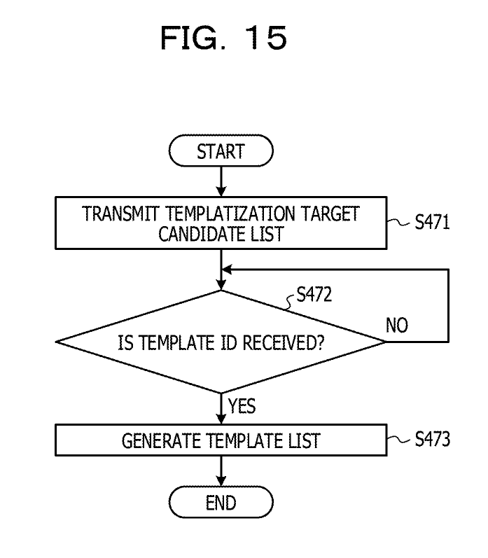

Next, the template generation processing and template response processing described above will be described with reference to FIG. 15 to FIG. 17.

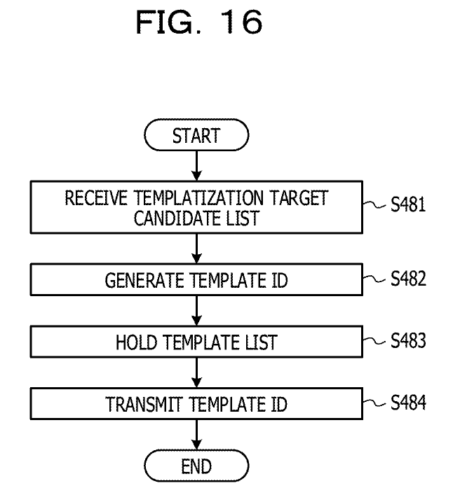

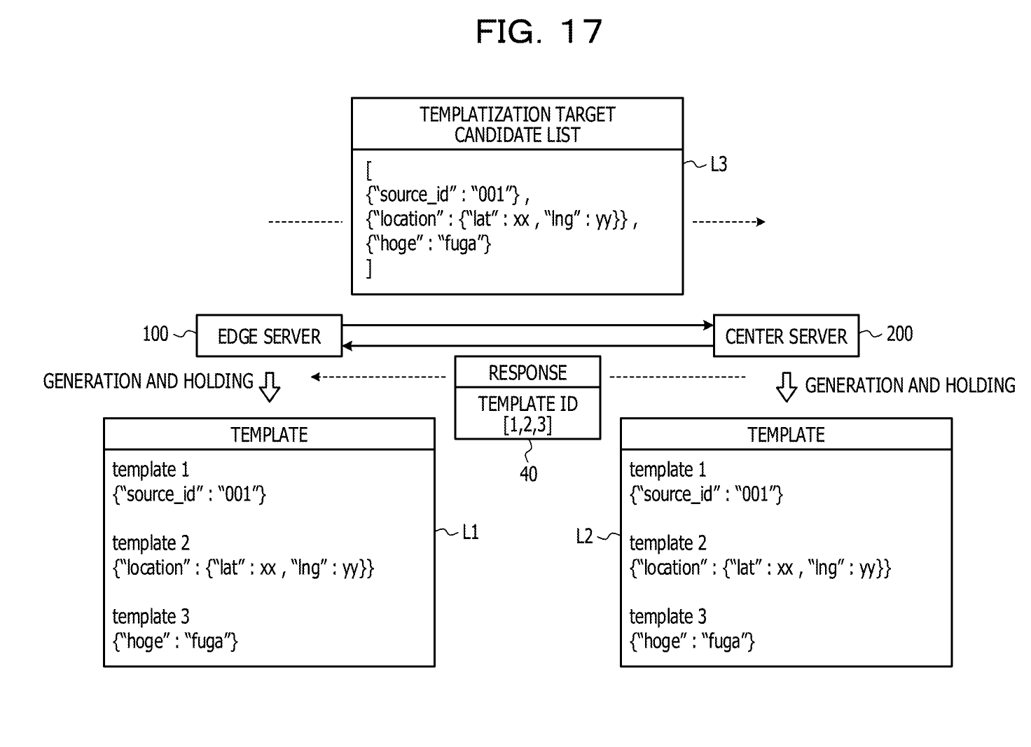

FIG. 15 is a flowchart illustrating an example of the template generation processing. FIG. 16 is a flowchart illustrating an example of the template response processing. FIG. 17 is a diagram illustrating generation of a template list. As described above, the template generation unit 104 and the template transmission and reception unit 107 perform the template generation processing independently from the processing described with reference to FIGS. 6A to 6C. First, as illustrated in FIG. 15, the template transmission and reception unit 107 transmits a templatization target candidate list (S471). In more detail, the template transmission and reception unit 107 periodically or non-periodically acquires the templatization target candidate list held in the template generation unit 104, and transmits the templatization target candidate list to the center server 200. Thereby, as illustrated in FIG. 17, a templatization target candidate list L3 is transmitted from the edge server 100 to the center server 200.

Subsequently, if the processing of S471 is completed, the template transmission and reception unit 107 waits until the template ID is received (S472: NO). Then, if the template transmission and reception unit 107 receives the template ID (S472: YES), the template generation unit 104 generates a template list (S473). For example, as illustrated in FIG. 17, if a response 40 including the template ID is transmitted from the center server 200 to the edge server 100, the template list L1 is generated based on the templatization target candidate list and the template ID.

Meanwhile, as illustrated in FIG. 16, if the template transmission and reception unit 202 receives the templatization target candidate list (S481), the decoding unit 203 generates the template ID (S482). In more detail, the decoding unit 203 generates the template ID for each combination of keys and values included in the templatization target candidate list. If the processing of S482 is completed, the decoding unit 203 holds the template list (S483). Thereby, as illustrated in FIG. 17, the center server 200 holds the template list L2 in which the template ID and the templatization target candidate list are associated with each other.

If the processing of S483 is completed, the template transmission and reception unit 202 transmits the template ID (S484). Thereby, as illustrated in FIG. 17, the response 40 including the template ID is transmitted from the center server 200 to the edge server 100.

As described above, according to the present embodiment, the information collection system S includes the center server 200 that collects meta information including a key and a value, and the edge server 100 that transmits the meta information to the center server 200. For example, the edge server 100 selects a target key for managing an appearance frequency of the value, based on characteristics of the meta information, and updates the appearance frequency of the value corresponding to the selected key. Then, the edge server 100 templatizes a combination of a value whose updated appearance frequency is greater than a threshold frequency and a key corresponding to the value. Thereby, a traffic of the meta information between the edge server 100 and the center server 200 may be adaptively reduced.

For example, in a case where the respective edge servers 100 illustrated in FIG. 1 transmit meta information having a size of approximately 1 Kbyte to the center server 200 at a rate of 1000 times per second, the communication network NW1 having a bandwidth of approximately 8 Mbps is demanded. However, as described above, if the template is applied to the meta information and the meta information to which the template is applied is compressed by a known compression technique, even in a case where the communication network NW1 has a bandwidth of approximately 1.5 Mbps, the edge server 100 may normally transmit the meta information without affecting other communications.

Although preferred embodiments according to the present disclosure are described in detail above, the present disclosure is not limited to the specific embodiment, and various modifications and changes may be made within the scope of the present disclosure described in claims. For example, since the meta information stored in the edge server 100 is transmitted and stored in the above-described center server 200, the center server 200 may perform the first update processing, the second update processing, the first determination processing, and the second determination processing. In this case, the center server 200 may specify a templatization target, generate a template ID, and generate a template list based on the specified templatization target and the generated template ID. Then, the center server 200 may transmit the template list generated by itself to the edge server 100, and the edge server 100 may hold the received template list. Time To Live (TTL: life expectancy) may be set to a target value whose appearance frequency is managed, and in a case where the appearance frequency is not updated for a certain time, the value may be deleted from the LFU arrangement.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information collection system comprising:
a center server that collects meta information including a key and a value; and
an edge server that transmits the meta information to the center server,
wherein the edge server is configured to:
select the key for managing an appearance frequency of the value, based on characteristics of the meta information,
update an appearance frequency of the value corresponding to the selected key, and
generating a template of a combination of a target value whose updated appearance frequency is greater than a threshold frequency and a target key corresponding to the target value.

2. The information collection system according to claim 1, wherein the edge server is configured to:
calculate a ratio between the number of elements of the value corresponding to an identification key for identifying a transmission source of the meta information and the number of elements of the value corresponding to the key except for the identification key, and
determine whether to generate the template of the combination of the target value and the target key based on the calculated ratio.

3. The information collection system according to claim 1, wherein the edge server is configured to
when the number of elements of the value corresponding to an identification key for identifying a transmission source of the meta information is equal to the number of elements of the value corresponding to the key except for the identification key, select the combination of the target value and the target key for generating the template.

4. The information collection system according to claim 1, wherein the edge server is configured to
when the number of elements of the value corresponding to the key except for an identification key with respect to the number of elements of the value corresponding to the identification key for identifying a transmission source of the meta information is less than or equal to a predetermined threshold, select the key for managing the appearance frequency of the value.

5. The information collection system according to claim 1, wherein the edge server is configured to
when the number of elements of the value corresponding to a key except for an identification key with respect to the number of elements of the value corresponding to the identification key for identifying a transmission source of the meta information is greater than a predetermined threshold, exclude the key for managing an appearance frequency of the value from a selection target.

6. The information collection system according to claim 1,
wherein the edge server is configured to select a combination of an identification key for identifying a transmission source of the meta information and the value corresponding to the identification key for generating the template.

7. An information collection method executed by a second computer transmitting meta information to a first computer performing processing of collecting the meta information including a key and a value, the information collection method comprising:
selecting the key for managing an appearance frequency of the value, based on characteristics of the meta information;
updating an appearance frequency of the value corresponding to the selected key; and
generating the template of a combination of a target value whose updated appearance frequency is greater than a threshold frequency and a target key corresponding to the target value.

8. The information collection method according to claim 7, further comprising:
calculating a ratio between the number of elements of the value corresponding to an identification key for identifying a transmission source of the meta information and the number of elements of the value corresponding to the key except for the identification key, and
determining whether to generate the template of the combination of the target value and the target key based on the calculated ratio.

9. The information collection method according to claim 7, further comprising
when the number of elements of the value corresponding to an identification key for identifying a transmission source of the meta information is equal to the number of elements of the value corresponding to the key except for the identification key, selecting the combination of the target value and the target key for generating the template.

10. The information collection method according to claim 7, further comprising
when the number of elements of the value corresponding to the key except for an identification key with respect to the number of elements of the value corresponding to the identification key for identifying a transmission source of the meta information is less than or equal to a predetermined threshold, selecting the key for managing the appearance frequency of the value.

11. The information collection method according to claim 7, further comprising
when the number of elements of the value corresponding to a key except for an identification key with respect to the number of elements of the value corresponding to the identification key for identifying a transmission source of the meta information is greater than a predetermined threshold, excluding the key for managing an appearance frequency of the value from a selection target.

12. The information collection method according to claim 7, further comprising
selecting a combination of an identification key for identifying a transmission source of the meta information and the value corresponding to the identification key for generating the template.

13. A non-transitory computer-readable storage medium storing a program that causes a second computer to perform processing, the second computer being configure to transmit meta information to a first computer performing processing of collecting the meta information including a key and a value, the processing comprising:
selecting the key for managing an appearance frequency of a value, based on characteristics of the meta information;
updating an appearance frequency of the value corresponding to the selected key; and
generating a template of a combination of a target value whose updated appearance frequency is greater than a threshold frequency and a target key corresponding to the target value.
